(19) United States
(12) Patent Application Publication
(10) Pub. No.: US 2014/0339832 A1
(43) Pub. Date: Nov. 20, 2014

(54) WIND ENERGY CONVERSION SYSTEM OVER WATER

(71) Applicant: Leonid Goldstein, Austin, TX (US)

(72) Inventor: Leonid Goldstein, Austin, TX (US)

(21) Appl. No.: 14/297,602

(22) Filed: Jun. 5, 2014

Related U.S. Application Data
(63) Continuation of application No. PCT/US12/71581, filed on Dec. 24, 2012.
(60) Provisional application No. 61/671,242, filed on Jul. 13, 2012.
(60) Provisional application No. 61/609,969, filed on Mar. 13, 2012.
(60) Provisional application No. 61/589,925, filed on Jan. 24, 2012.
(60) Provisional application No. 61/586,782, filed on Jan. 14, 2012.
(60) Provisional application No. 61/584,358, filed on Jan. 9, 2012.
(60) Provisional application No. 61/581,217, filed on Dec. 29, 2011.
(60) Provisional application No. 61/580,916, filed on Dec. 28, 2011.

(51) Int. Cl. F03D 5/00; F03D 9/00

(52) U.S. Cl. CPC F03D 5/00; F03D 9/002
USPC 290/55

(57) ABSTRACT

A wind energy conversion system, comprising a wind powered airfoil (101) tethered to a vessel (103), an electrical generator (305, 702) powered by the motion of the vessel, an electrical cable (113, 710) connecting the generator to the land. Multiple aspects and embodiments are disclosed.

### CROSS REFERENCE TO RELATED APPLICATIONS

This application is a continuation of PCT Application No. PCT/US12/71581, filed 24 Dec. 2012, which claims the benefit of U.S. Provisional Applications No. 61/580,916, filed 28 Dec. 2011, No. 61/581,217, filed 29 Dec. 2011, No. 61/584,358, filed 9 Jan. 2012, No. 61/586,782, filed 14 Jan. 2012, No. 61/589,925, filed 24 Jan. 2012, No. 61/609,969, filed 13 Mar. 2012 and No. 61/671,242, filed 13 Jul. 2012 by the same inventor as herein, the entire disclosure of which is incorporated herein by reference.

### BACKGROUND OF THE INVENTION

The invention is generally directed to wind energy conversion systems and methods. Windmills have been used by humans for at least 2,500 years. Wind turbines for converting wind energy into electrical energy (or electricity generation, in a simple language) have been built since 1887. In the 20th century, a concept of airborne wind energy conversion systems was introduced. For example, Miles Loyd in the article “Crosswind Kite Power” (Energy journal, 1980; 4:106-11) taught AWEC systems and methods, using an airborne wing, moving cross wind with the speed, exceeding the speed of the wind. One of the challenges encountered by wind energy conversion systems is difficulty of deployment in offshore environment. The offshore wind turbines are much more expensive, because it is more difficult to resist horizontal forces, exerted by the wind on the blades of the wind turbine. One attempt to use water medium as a friend, rather than a foe, is described in an article by J. Kim and C. Park “Wind power generation with a parawing on ships, a proposal.” (Energy journal, 2010; 35:1425-32). This approach has a number of shortcomings. It involves very expensive steps of converting electrical energy into chemical energy by hydrolysis or some similar process, then storing hydrogen on board of the ship. Further, surface ships that are utilized in it are expensive and have high wave resistance that decrease wind energy conversion efficiency.

This invention is directed to solving the problem of wind energy conversion into electrical energy in offshore environment, using water medium synergistically.

### SUMMARY OF THE INVENTION

In one aspect, the invention is a wind energy conversion system, comprising a wind attacked airfoil, a body submerged in water, an electrical generator with a rotor and a stator; some means for converting relative motion of the airfoil into motion of the body submerged in water relative to the water; some means for converting relative motion of the body submerged in water into rotational motion of the rotor; and an electrical cable connecting the electrical generator to a destination on land. The system can be further equipped with a computerized control system with one or more microprocessors, sensors and actuators.

In most embodiments, the body moves in the water, but in some embodiments the body is a water wheel or turbine, rotating around its axis, and the water is moving relative to it. The body can be submerged in the water completely or partially. The airfoils can be airborne wings or blades of a wind turbine rotor. The body can comprise a hydrofoil and/or propeller and/or water turbine or wheel and/or underwater chamber wall. The airborne wing can transfer its motion to the mentioned body submerged in water by a flexible tether. The wind turbine blade can transfer its motion to the mentioned body submerged in water by either a rigid connection or a cable. A cable or a belt, rotating a pulley, a sprocket or a drum, rotationally connected to the rotor, can be used for converting motion of the hydrofoil into rotational motion of the rotor. The underwater propeller, the water turbine or the water wheel can be rotationally connected to the rotor of the electrical generator with or without a gearbox. Rotation of an underwater chamber with a curved wall can create a water stream, which would transfer the motion to a water wheel or a water turbine, rotationally connected to the rotor of the generator.

One embodiment of the invention is a wind energy conversion system, comprising at least one vessel, placed in the water and moving in the water; a wing, placed in the air and moving in the air under wind power and equipped with a tether, connecting the wing and the vessel, or a sail, attached to the vessel; the vessel either has a form and/or employs underwater control surfaces that allow it to move in water horizontally with relatively low resistance in one axis and prevents it from significant movement in the perpendicular axis; at least one motion transmitting cable or belt, attached with one end to the vessel and with another end to a device, converting tangential motion of the cable into rotational motion; and an electrical generator.

Here, the part of the, converting motion of the cable to electrical energy is floating on the surface, being anchored to the bottom; or it is installed on a column, driven into a bottom; or it is installed on shore; or it is installed on the bottom; or it is floating and drifting with low speed (compare to the vessel), not being anchored. It is connected by cables to the grid or another energy consumer on the land. There may be plurality of motion transmission cables or generators. The wing can be rigid or flexible or soft or mixed. The wing can be a kite, or a parafoil or an inflatable wing. The sail can be rigid or flexible or mixed; it can be attached to a mast or without mast. The movement of the vessel and the wing or the sail is controlled automatically by an electronic system. The vessel has a rudder for directional control and another rudder for depth control. One of the advantageous forms for the vessel is a wing with controlling appendages.

Another embodiment of the invention is a wind energy conversion system, comprising at least one vessel, placed in water and moving in the water; a wing, placed in the air and moving in the air under wind power with a tether, connecting the wing and the vessel, or a sail, attached to the vessel; the vessel either has a form and/or employs underwater control surfaces that allow it to move in water horizontally with relatively low resistance in one axis and prevents it from significant movement in the perpendicular axis; an electrical generator, installed on top or inside the vessel; a propeller, installed on the vessel and completely submerged into the water in such a way, that relative flow of water rotates the propeller; the propeller transfers its motion to the rotor of the electrical generator; and the electrical generator is connected to a destination on land by an underwater electrical cable.

The vessel may have multiple generators and/or water rotors. The electrical cable is connected to the grid or another energy consumer. The water rotor can be an open propeller, a shrouded propeller, a water turbine or wheel. The movement of the vessel and the wing is controlled automatically by electronic system. The vessel has a rudder for directional control and a rudder for depth control. One of the advantageous forms for the vessel is a wing with controlling appendages. Another embodiment of the invention is a wind energy conversion system, comprising at least one wing, placed in the air at angle to the wind and moving in the air; at least one vessel, placed in water and moving in the water; a buoy or a leg, placed in water and attached to the bottom; a tether, connecting the wing and the buoy; at least one vessel, placed in water and moving in the water, and attached to the tether by a cable; and either the vessel has a water rotor and an electrical generator, connected by an electrical cable to a destination on land or there is a motion transmitting cable or belt, attached with one end to the vessel and with another end to a device, converting motion of the cable to electrical energy; this device comprises an electrical generator connected by an electrical cable to a destination on land.

Another embodiment of the invention is a device for converting energy of wind into electrical energy, deployed over water, comprising an electrical generator with a rotor and a stator, a water turbine or wheel, rotationally connected to the rotor; one or more airfoils, moving under power of wind; a frame, connected to the airfoils and rotating under influence of the wings in approximately horizontal plane; one or more hollow bodies with underwater inlets, connected to the frame; operated in such a way that the water enters the hollow bodies and accelerates toward the water turbine or wheel and acts on the turbine's blades or wheel's paddles. The airfoils can be attached to the frame or be airborne. Having at least two airfoils, connected to a single frame is preferable.

Another embodiment of the invention is a hydrodynamic transmission performing transfer of rotational motion from a rotating part with a larger diameter to a coaxial rotating part with a smaller diameter with increase in angular velocity, comprising a first rotating element; a second rotating element of smaller diameter, rotating around the same geometrical axis as the first rotating element; a body of liquid; a turbine or a wheel with plurality of blades, connected to the second rotating element; a chamber, at least partially submerged into the liquid, having such a form that it is continuously the liquid and accelerating it toward the turbine or the wheel, where this liquid transfers its energy to the turbine or wheel. This can be called a centripetal liquid drive. The first rotating element has diameter at least two times larger than the second rotating element, and external water is used as the liquid.

Another embodiment of the invention is a vertical axis wind turbine deployed over water, comprising at least one aerodynamic surface, moving under power of wind; at least one electrical generator with a rotor and a stator, placed slightly above or below water surface and attached to the wing; a water propeller, placed in proximity of the generator and rotationally connected to its rotor; the water propeller is submerged in the water, having its geometrical axis substantially horizontal and substantially coinciding with its momentarily direction of movement.

Another embodiment of the invention is a method of converting wind energy into electrical energy, including steps of providing a horizontally rotating frame, that is brought to motion by energy of wind; providing at least one electrical generator near water surface, attached to this rotor close to its periphery; providing a water propeller or another water rotor, that is brought to motion by relative flow of water; making the propeller or another water rotor to rotate the rotor of the electrical generator.

Another embodiment of the invention is a method for converting wind energy into electrical energy, comprising steps of providing a wind attacked airfoil (such as a wing or a turbine blade), an underwater foil surface (a hydrofoil or a propeller blade), and an electrical generator with a rotor and a stator; using the airfoil to harvest wind energy and bring into motion the underwater foil surface; converting the motion of the underwater foil surface into rotation of the rotor of the electrical generator, generating electrical energy and transferring the generated electrical energy by an electrical cable to a destination on land.

### BRIEF DESCRIPTION OF THE DRAWINGS

The accompanying drawings illustrate the invention. The illustrations omit details not necessary for understanding of the invention, or obvious to one skilled in the art, and show parts out of proportion for clarity. In such drawings:

FIG. 1A Perspective view of a wing, a vessel and a generating station in the working phase

FIG. 1B Vessel front view of the same

FIG. 1C Schematic top view with a motion scheme in one embodiment

FIG. 1D Scheme of optional wing motion in the vertical projection

FIG. 2 Schematic top view with a motion scheme in another embodiment

FIG. 3 Generating station internals in one embodiment

FIG. 4 Generating station internals in another embodiment

FIG. 5A Side view of a vessel with a heavy keeled hull

FIG. 5B Top view of the same

FIG. 5C Sectional view of the same

FIG. 6A Side view of a vessel with a sail instead of the flying wing

FIG. 6B Top view of the same

FIG. 7A Side view of a vessel with a generator and an underwater prop, and a wing

FIG. 7B Top view of the same

FIG. 7C Front view of the same

FIG. 8A Top view of a vessel with a generator, attached to a buoy, and a wing

FIG. 8B Side view of the same

FIG. 8C Front view of the same

FIG. 9 Side view of a vessel with a sail, an underwater prop and a buoy

FIG. 10 Side view of a vessel with a mastless sail

FIG. 11 A rigid wing with control surfaces

FIG. 12 A flexible wing with a control device

FIG. 13A Front view of a vertical axis wind turbine with a centripetal liquid drive

FIG. 13B Top view of the same

FIG. 13C Partial side view of the same

FIG. 14A Front view of a vertical axis wind turbine with an alternative drive

FIG. 14B Top view of the same

FIG. 15 Top sectional view of a part of the same

FIG. 16A Front view of a vertical axis wind turbine with secondary turbines

FIG. 16B Partial side view of the same

### DETAILED DESCRIPTION OF THE INVENTION

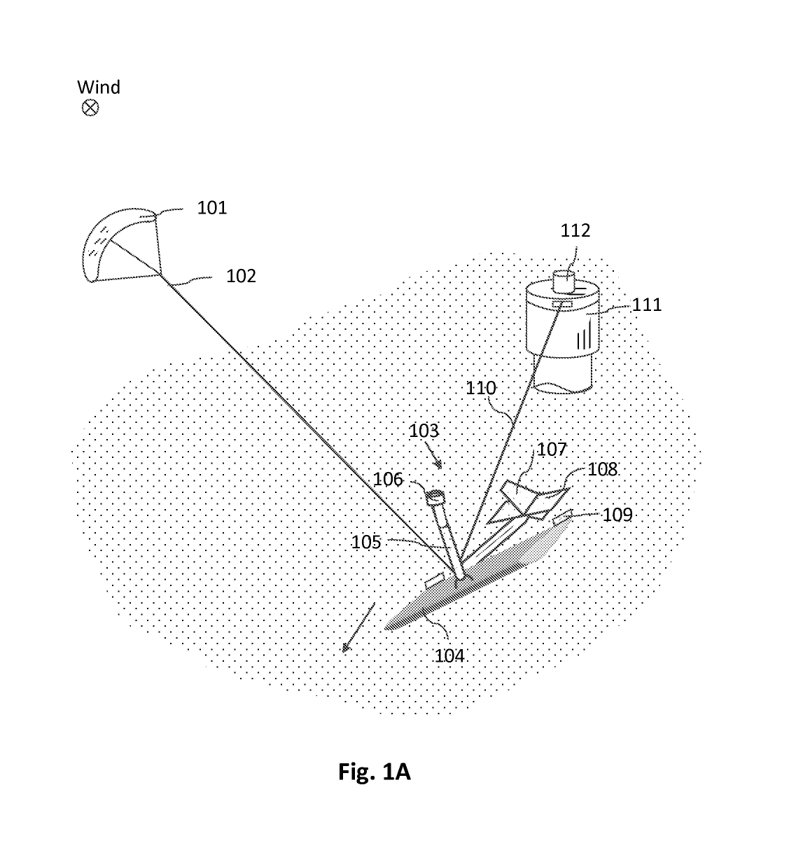

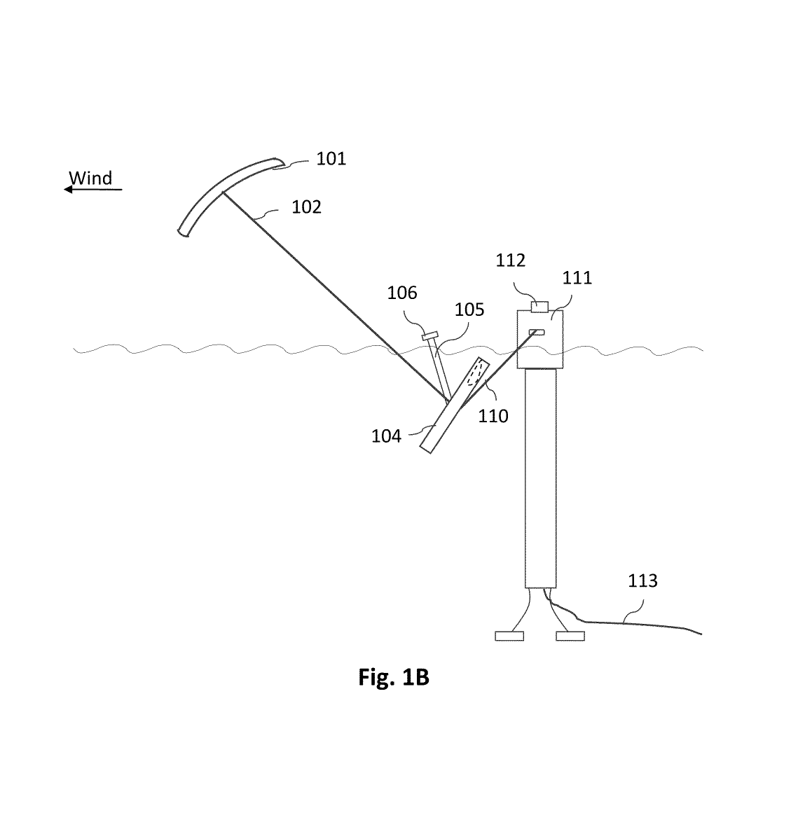

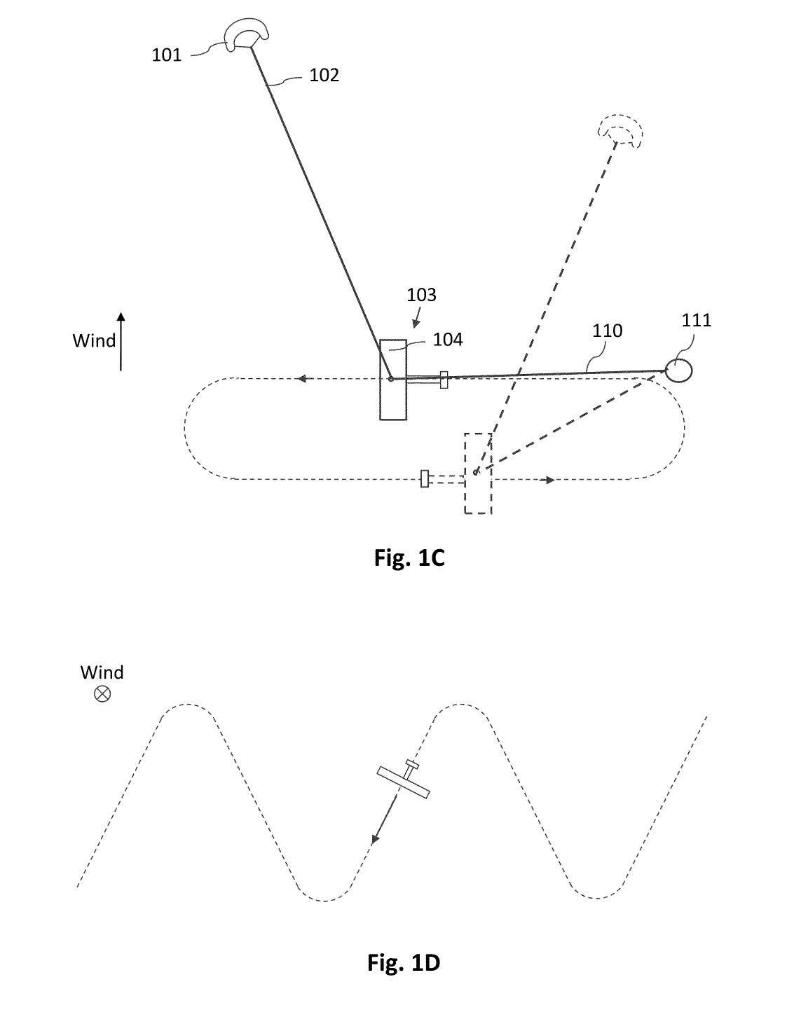

FIG. 1A shows one embodiment of the invention. A wing 101 is placed in the air at an angle to the wind, and is pulling a tether 102. A tether 102 is attached by its other end to a vessel 103, which is placed in the water. Vessel 103 in this figure moves perpendicular to the wind, as shown by the arrow near it. Vessel 103 comprises an underwater wing (a hydrofoil) 104, a mast 105 which is partially under water, an electronic subsystem 106 on top of mast 105 above the water and underwater control surfaces: a yaw rudder 107, a pitch rudder (a diving plane) 108 and ailerons (wing roll control surfaces) 109. Moving vessel 103 pulls after itself a cable or belt 110, that brings into motion a rotor of an electrical generator inside a generating station 111. A control system 112 is attached to or integrated with generating station 111. Vessel 103 and/or generating station and/or wing 101 itself also comprise additional control means for controlling wing 101. Wing 101 is controlled automatically. The wind in FIG. 1A is directed from the observer. An arrow near underwater wing 104 shows direction of its movement. Underwater wing 104 can have profile NACA4312, for example.

Wing 101 can be any of the following: a rigid wing, like planes, gliders or ground based wind turbines have; a flexible wing; a soft wing; an inflatable wing; an inflatable wing, inflated by the ram air, entering it through holes; a kite wing; a paraglider wing; a wing, using soft materials, spread over a rigid frame or cables; a wing made of elastic fabric, receiving airfoil form from relative air flow; and/or a mixed wing, using different construction techniques in different parts of the wing. Wing 101 can be made of various materials, including carbon fiber, fiberglass, wood, aluminum, aramids, para-aramids, polyester, high or ultra high molecular weight polyethylene, nylon and others. Wing 101 can have various planforms; a wing, tapering to the ends in chord or thickness or both is possible (rectangular planform is shown on the drawings for clarity purposes only). Wing 101 may have wingtips to decrease turbulence and noise.

Vessel 103 should have small positive buoyancy. Underwater wing 104 can have steel, aluminum or fiberglass skin with polyethylene foam or light wood inside. Generating station 111 comprises means for converting linear energy of linearly moving cable 110 into electrical energy and means for pulling and stowing cable 110 in the returning phase. Such means are well known in the art, for example from U.S. Pat. No. 7,504,741 by Wrage, but will be described shortly. Tether 102 and cable 110 are made of strong material, resistant to water and UV radiation, or having resistant coating, preferably fiber based, such as para-aramid or ultra high molecular weight polyethylene. An aerodynamically streamlined cable can be used for tether 102. Mast 105 should be allowed to rotate relative to wing 104 in order to have its top above the water whether the wing is inclined to the port or to the starboard.

Control system 112 typically comprises a central processor or a microcontroller, optional sensors and communication means for communicating with electronic subsystem 106 on vessel 103 and/or control system of wing 101, if present. Preferable communication means is a wireless network, although optical or copper wires, going through cable 110 can be used, too. The sensors may include anemometer, barometer, radar, thermometer, GPS, cable tension meter, RPM meter, cameras for observing the wings and other. One control system 112 can serve multiple generating stations. Control system 112 can be connected to the Internet to receive general weather information, especially warnings of extreme weather events.

Electronic subsystem 106 of vessel 103 typically comprises a central processor or a microcontroller, actuators, optional sensors, communication means for communicating with control systems 112, navigational lights. Electronic subsystem 106 controls movable hydrodynamic control surfaces 107, 108 and 109, allowing vessel 103 to keep depth, stay on course, change course when direction of wind changes, perform turns in horizontal plane, and resist tension of tether 102 and tension of cable 110. The optional sensors may include speed meter, sonar, depth meter, accelerometer, gyroscopic sensor, GPS, compass, cameras and other.

For further explanation we will introduce a coordinate system, in which axis X is the direction of the wind, axis Y is a vertical axis and axis Z is a horizontal axis, perpendicular to the direction of the wind.

FIG. 1B is a view in the plane XY, FIG. 1C is a view in the plane XZ (top view). Thin dashed line in FIG. 1C shows trajectory of vessel 103, constructed around wing 104, in constant wind. Thick dashed lines show vessel 103, wing 101 and tether 102 in the returning phase. Underwater wing 104 is oriented with its cambered (i.e., high pressure) side up and sideways, so that its lift is directed down and away from wing 101, resisting a component of the tension of tether 102. Generating station 111 is floating in the water, attached to the bottom by anchors, or installed on columns, driven into the bottom, or installed on the shore.

The working cycle of the system consists of the working phase and the returning phase. In the working phase, wing 101 moves under influence of wind and pulls tether 102. Tether 102 exerts force F on vessel 103. Vessel 103 moves generally along axis Z away from generating station 111. Hydrodynamic lift force, acting on underwater wing 104, compensates vertical (axis Y) and downwind (axis X) components of force F. In FIG. 1B (plane XY), hydrodynamic lift is directed down and right, perpendicular to wing 104 and opposite to projection of tether 102. Remaining Z component of force F pushes vessel 103 along axis Z. Vessel 103 pulls cable 110. Cable 110 moves rotor of the generator in generating station 111, that produces electrical energy. Electrical energy is transferred to users or to the grid via an underwater or underground electrical cable 113. Wing 101 moves cross wind with speed, higher than the speed of the wind. Lateral axis of wing 101 is slightly inclined to the horizon. The aerodynamic lift, acting on wing 101, supports wing 101 in the air and creates force F (the tension in the tether), described above. There is wide selection of trajectories, in which wing 101 can move in the working phase. One simple option is for both vessel 103 and wing 101 to move perpendicular to the wind and parallel to each other with the same speed. Wing 101 would have some lead, of course. In this option, the speed of wing 101 is equal to speed of vessel 103. It may be preferential for wing 101 to move in the air faster, than vessel 103 moves in the water. For this purpose, wing 101 can move in a trajectory, shown in FIG. 1D (plane XY). In this option, the wing moves with a constant speed perpendicular to the wind along a curved trajectory. The wing's speed is much higher than a speed of vessel 103, while the average velocity of wing's projection to the horizontal plane equals vessel's velocity. Optionally, wing 101 can move substantially horizontally at the angle 45 to 89 degrees to the wind (the angle is measured between the wing's chord and the true wind).

In the returning phase, wing 101 moves under influence of wind in the opposite direction and pulls cable 102. Tether 102 exerts force F on vessel 103. Vessel 103 moves generally along axis Z toward generating station 111. As distance between vessel 103 and generating station 111 decreases, generating station pulls and stows the released length of cable 110 with small force (for example, winding it on a drum). In the returning phase wing 101 flies parallel to vessel 103, wind permitting.

Control surfaces 107, 108 and 109, controlled by electronic subsystem 106 ensure that vessel 103 holds specified depth, moves along stable path, shown in FIG. 1C and turns 180 degrees when switching between working and returning phases. Wing 101 changes general direction of its motion to the opposite when working phase changes to returning phase and vice versa. This change can be performed by yawing. If the wind changes, direction of vessel movement changes, too. How to control a tethered wing is well known in the art. Some examples include U.S. Pat. No. 7,546,813 by Wrage and U.S. Pat. No. 8,117,977 by Reusch. In many variants of this embodiment, design speed of vessel 103 will be between 10 m/s and 30 m/s.

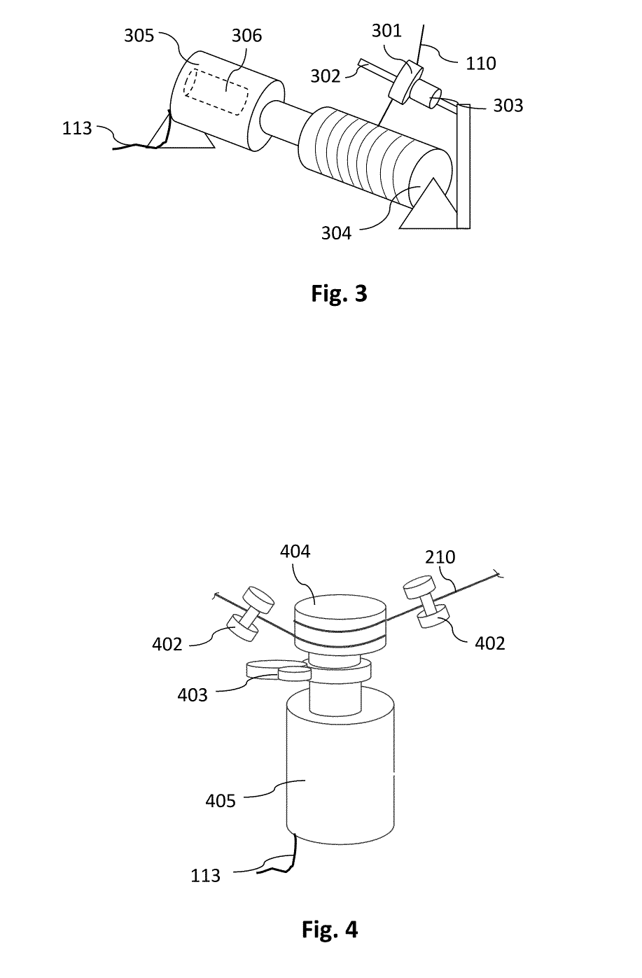

While it can be easily derived from the known art, we will describe one possible implementation of internals of generating station 111 with reference to FIG. 3. Cable 110 goes around a pulley 301 and unwinds from a drum 304 (in the working phase), while rotating it with force. Drum 304 transfers rotation to a rotor 306 of an electrical generator 305. Pulley 301 can move along a shaft 302 under influence of a shifting means 303, winding/unwinding the cable over the whole length of the drum 304. In the returning phase, electrical generator 305, acting as an engine, rotates the drum 304 in the opposite direction, pulling cable 110 and causing it to wind about drum 304. Generated electrical energy is transferred to consumers via cable 113. The electrical generator should be isolated from water. This embodiment is specially directed at offshore electrical energy production. Compared with traditional offshore horizontal axis wind turbine, advantages of this embodiment are:
it does not require a tall tower with nacelle, rotor hub and a generator on top; electrical generator is placed near the water level; therefore, the forces on the fixed or buoyed structure are exerted near the water level, rather than on the altitude of the hub center
the forces are smaller for the same power and less variable
consequently, it is much easier to balance and stabilize the fixed structure, containing the generator
high linear speed of the cable, driving the rotor, translates into high angular speed of the rotor and eliminates need in gearbox, or allows using a gearbox with low ratio
air velocity and forces, acting on flying wing are approximately the same over the whole length of wing, as opposite to the situation with HAWT blades
flying wing can be made from fabric, very light and inexpensive
winds on high altitudes can be used, allowing more stable electrical generation

Consequently, the capital costs per kW and kWh of energy are much lower, compared with the known art.

A (small) disadvantage of the embodiment in FIG. 1 is that electrical energy is not produced in the returning phase (which will be usually shorter than the working phase, because vessel 103 does not have to give its energy to the generator in the returning phase). One way to overcome this shortcoming is to connect two vessels 103, each with its own wing 101, to a single generating station 111. Moving in a counter phase, with wings, flying in different altitude ranges, these vessels can move the rotor of the generator in the generating station 111 all the time, ensuring continuous energy output.

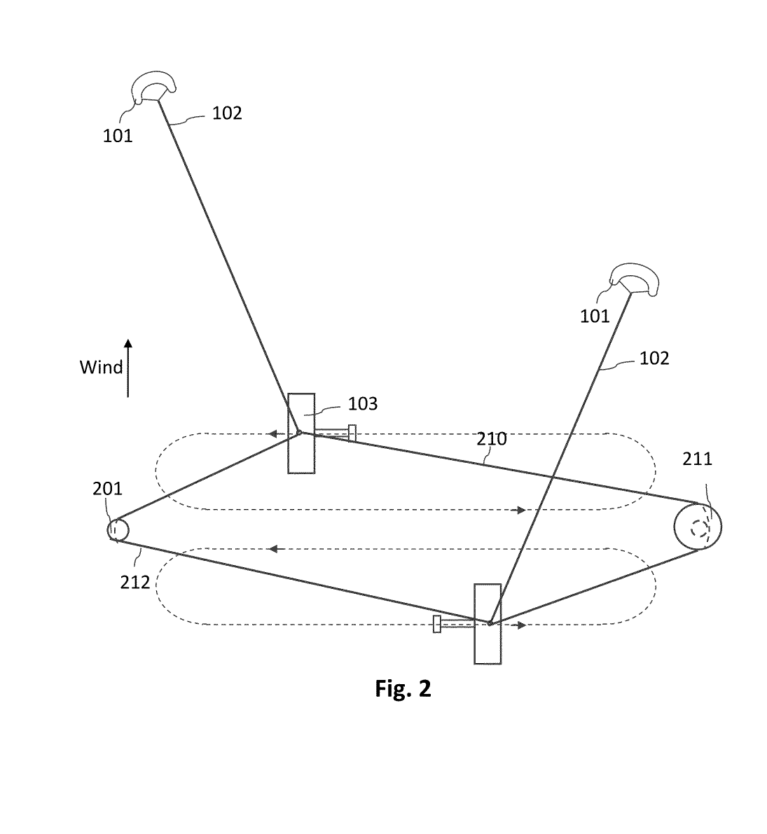

Another embodiment with a similar idea is depicted in FIG. 2, which is a view of plane XZ. This embodiment comprises two vessels 103, each connected to its wing 101 by its tether 102. In addition, there is a generating station 211, similar to generating station 111 from previous embodiments, and a pulley station 201. Two other cables are connected to vessel 103: a cable 210, transferring kinetic energy of moving vessels to generating station 211, and cable 212, simply wrapped around a pulley inside pulley station 201. Pulley station 201 is anchored to the bottom or installed on a column, driven to the bottom. Wings 101 of the two vessels fly at different altitude ranges to prevent collisions between them and their corresponding tethers 102.

Trajectories of vessels 103 in this embodiment are shown in FIG. 2. In this embodiment, both vessels 103 continuously rotate the rotor of a generator, installed in the generating station 211. In the position, shown in FIG. 2, the vessel, moving to the left, transfers its kinetic energy directly by pulling the cable 210. The vessel, moving to the right, pulls the cable 212, which pulls the cable 210, attached to the vessel, moving to the left. Cables 210 and 212 are similar to cable 110.

This embodiment can be implemented by wrapping cable 210 around a rotating element of generating station 211 and the pulley of pulley station 201 and connecting its ends one to another, forming a loop. Vessels 103 are attached to this loop.

FIG. 4 shows internals of generating station 211. Cable or belt 210 wraps around a drum 404 (which can be also a pulley or a sprocket, sprocket being used with a perforated belt) at least once, or as necessary to prevent slippage. In the FIG. 4, one end of cable 210 leads to the first vessel 103, another end of cable 210 leads to second vessel 103. Drum 404 rotates the rotor of an electrical generator 405, either directly or via a reverse gear 403. When the first vessel 103 moves away from generating station 211, drum 404 rotates the rotor directly, when the second vessel 103 moves away from generating station 211, reverse gear 403 is engaged, so generator's rotor always rotates in the same direction. Generator 405 produces electrical energy, that is sent to energy consumers via cable 113. Optionally, cable dryers 402 is employed. Dryer 402 blows off water and dries up cable/belt 210 on the side where it is pulled from outside in order to provide better friction. Dryers are not required, if perforated belt is used with a toothed pulley or a sprocket. Advantage of this embodiment is that it produces energy continuously at full rate, allowed by the generator rating and the size and motion of both wings 101. Disadvantage of this embodiment is that efficiency decreases, when wind's direction shifts far from being perpendicular to the line generating station—pulley station. Pulley station 201 can be made slowly movable, or multiple pulley stations 201 at some distance with a mechanism to switch between them can be provided, with the purpose to overcome this shortcoming.

Multiple vessels 103 can be connected to a single generating stations. Multiple wings 101 can be connected to a single vessel 103. Vessel 103 can be equipped with a sonar, warning when the vessel is going to hit fish or underwater vegetation, and avoid them, slow down or even stop. In vessel 103, yaw rudder 107 can be attached to an additional yaw stabilizer, and pitch rudder 108 can be attached to an additional pitch stabilizer, or they can serve as stabilizers themselves. Other forms of vessel, not based on underwater wing, are possible. Vessel 103 can include means to change length of tether 102.

For higher efficiency, multiple generating stations can be combined into a single wind farm, and work in overlapping phases. Combining outputs of multiple generating stations will make power output smoother. The embodiments, described above, can be deployed in oceans, seas, rivers, lakes, ponds, reservoirs of hydraulic power stations etc.

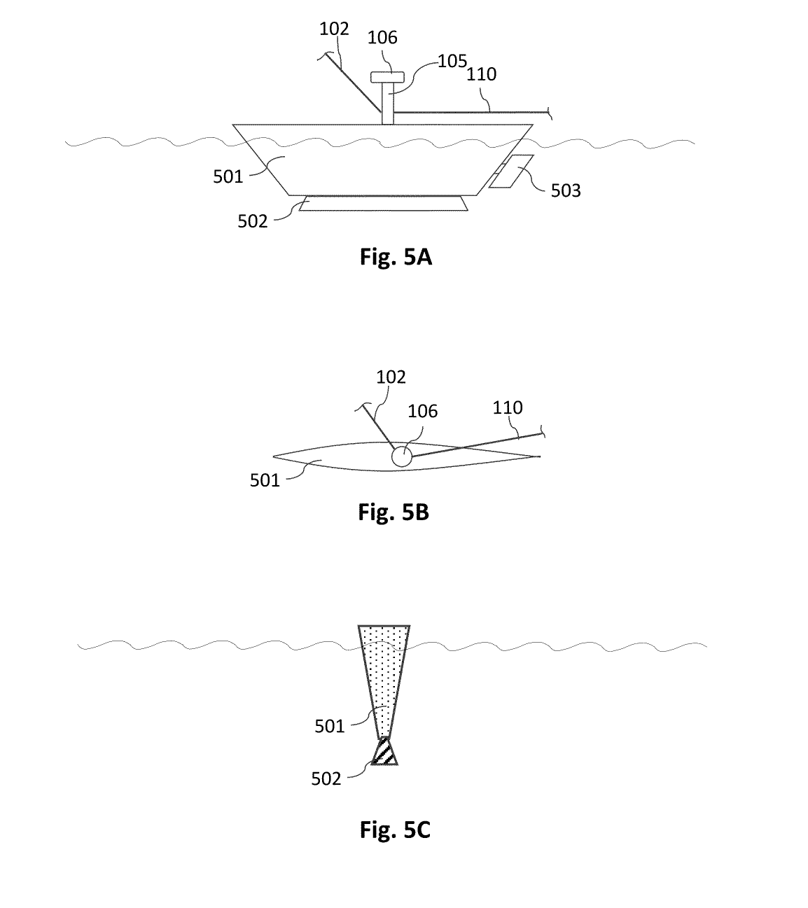

In more embodiments, vessel 103 is not necessarily constructed around a wing 104. FIGS. 5A, 5B and 5C depict another embodiment, in which vessel 103 is a “usual”, displacing keeled boat. It comprises a hull 501 and a combined ballast/keel 502. Hull 501 can be made of light wood, or of fiberglass skin with polyethylene foam inside, and provide sufficient buoyancy. Hull 501 should have low drag form. Ballast/keel 502 is made of steel or iron. Vessel 103 has a standard rudder 503 in this embodiment. Mast 105 with electronic subsystem 106 on top is installed on top on hull 501. Tether 102 and cable 110 are attached to the lower part of mast 105. Other known hull types are possible, including a multihull, an underwater hull, a hull with wing.

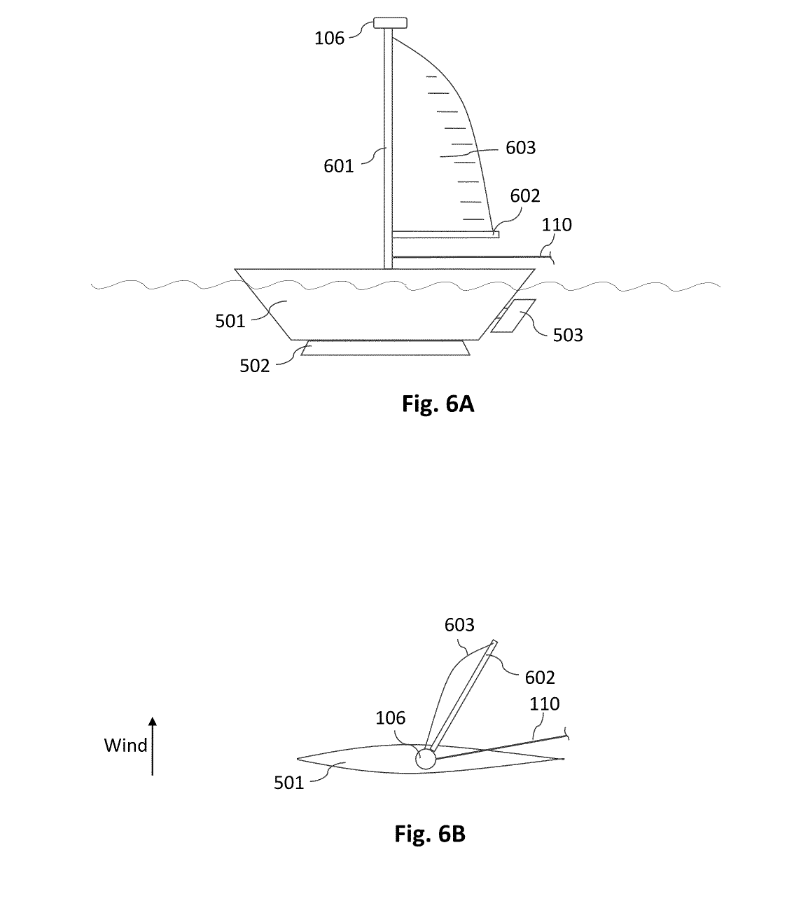

In another embodiment, a sail is used instead of wing 103. FIGS. 6A and 6B show an example of such embodiment. In it, vessel 103 retains hull 501, keel/ballast 502 and rudder 503, but also has a sail mast 601, a boom 602 and at least one sail 603. Electronic subsystem 106 is installed on top of sail mast 601, and cable 110 is attached to the lower part of mast 601 or to the stern of vessel 103. This embodiment shows a displacing, ballasted, keeled hull. Other known hull types are possible, including a multihull, an underwater hull, a hull with a wing, an underwater wing.

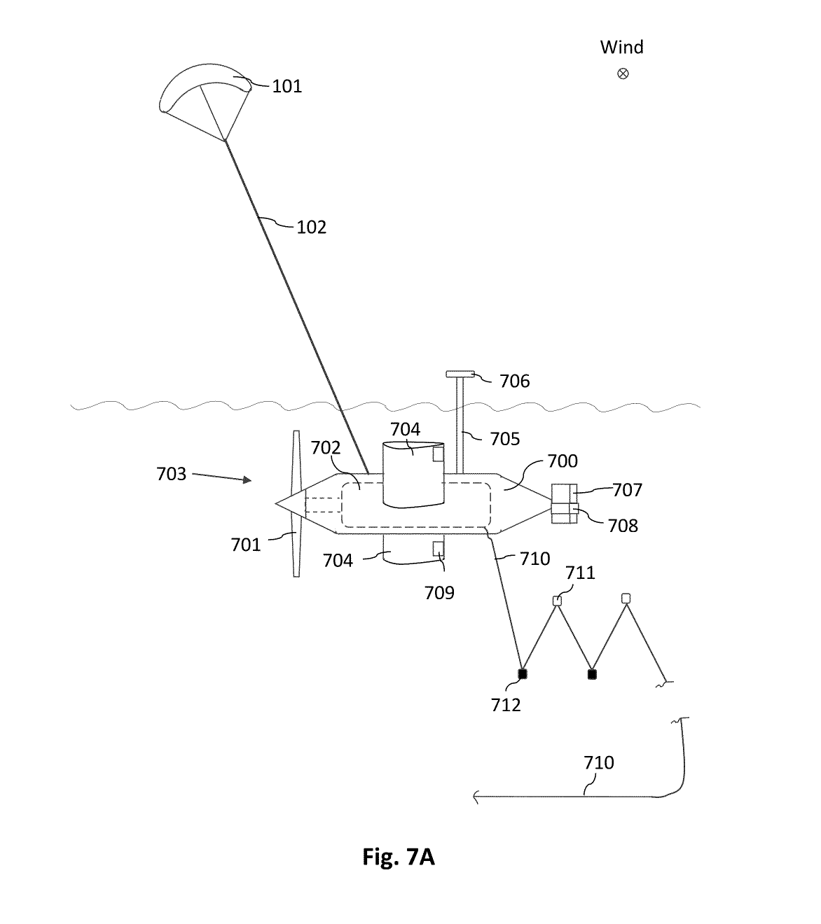

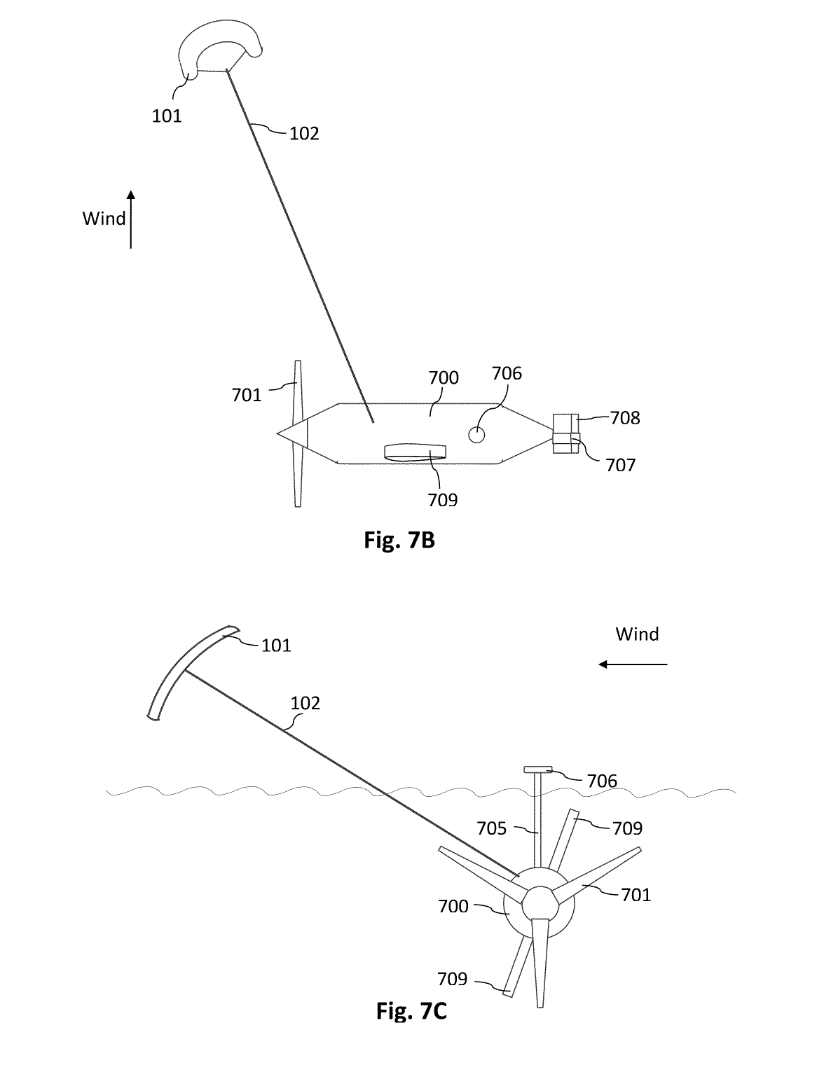

FIGS. 7A, 7B and 7C show one more embodiment of the invention. FIG. 7A is a side view, FIG. 7B is a top view, FIG. 7C is a front view. Wing 101 is placed in the air at an angle to the wind, pulling tether 102. Tether 102 is attached by its other end to a vessel 703, which is placed in the water. Vessel 703 comprises a pair of underwater wings 704, a mast 705 which is partially above water, an electronic subsystem 706 on top of mast 705 above the water and underwater control surfaces: a yaw rudder 707, a pitch rudder (a diving plane) 708 and ailerons (wing roll control surfaces) 709. On the pictures, yaw and pitch rudders are shown attached to a vertical and horizontal stabilizers, accordingly. A propeller 701 is installed in the forward part of vessel 703, and an electrical generator 702 is housed inside of vessel's watertight hull 700. An electrical cable 710 is connected to the armature of generator 702, eventually lays on the bottom and is connected to a consumer, or to an intermediary concentrating/converting/transforming station of a wind farm, to which this vessel belongs. Small buoys 711 and small weights 712 can be attached to electrical cable 710 intermittently in such way, as to allow significant length of electrical cable 710 to float at half depth of the location. Except for mast 704 and control system 706 on top of it, vessel 703 is under water deep enough that it does not create a significant surface wave and propeller 701 does not hit the air. Underwater wing 704 is similar in its construction, operation and function to wing 104.

In this embodiment, vessel 703 moves linearly much of the time, preferably (but not necessary) perpendicular to the momentarily direction of the wind. In the constant wind, vessel 703 moves back and forth with smooth turns at the ends. As vessel 703 moves forward, pulled by wing 101, relative water flow rotates propeller 701, which rotates rotor of generator 702 directly or through a simple gearbox. Generator 702 generates electrical energy, which is transferred to a consumer or a concentrating/converting substation, serving the wind farm, through electrical cable 710. Much of the electrical cable 710 is floating underwater in order to allow certain freedom of movement to vessel 703. When vessel 703 reaches limits of the electrical cable length, or approaches borders of area, in which it is allowed to move (as it can detect using GPS), it smoothly turns 180 degrees. Other vessel paths, such as ellipse or oval, are possible. Movement of vessel 703 and wing 101 are controlled by its electronic subsystem 706, which may be controlled by a master control system of the wind farm. Wireless or satellite connection can be utilized for this connection.

Many other aspects of construction and operation of this embodiment are similar to those in previous embodiments. This embodiment can use a sail instead of flying wing 101, and vessel 703 can have various hull forms, including multihull and a keeled hull without wings. Generator 702 can be above the water. An open propeller 701 is shown in the picture, but other types of rotors can be used, such as a shrouded turbine with rotor blades and stator vanes, having opposite directions. Multiple propellers 701 and/or generators 702 can be used with a single vessel 703. In a variation of this embodiment, electrical cable 710 connects generator 702 to a ship or other mobile customer.

Some of the advantages of this embodiment:
it does not require fixed or even anchored structures and can be deployed in any place where electrical cable can reach
it can be easily deployed, removed or relocated
the whole system and be easily moved away from path of a storm, if necessary
the whole system can be easily brought to a shore for service
multiple vessels 103 can be moving in the same area, with flying wings on different altitudes and combined in a wind farm

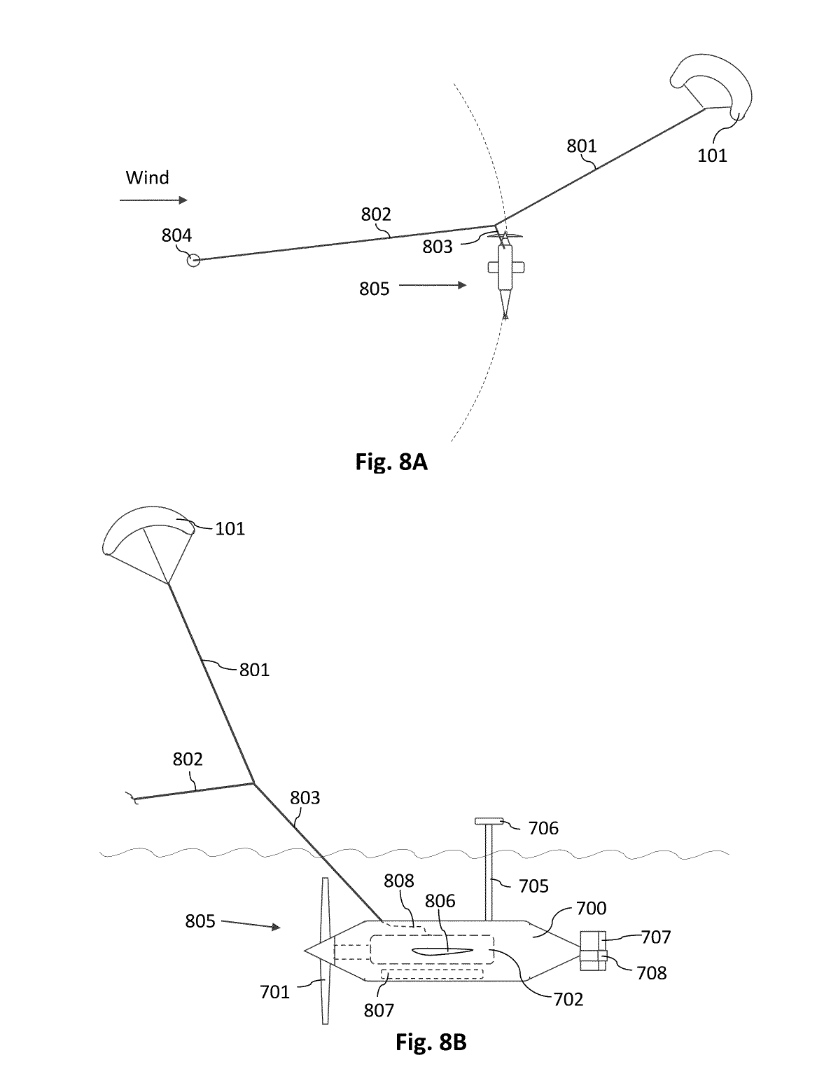

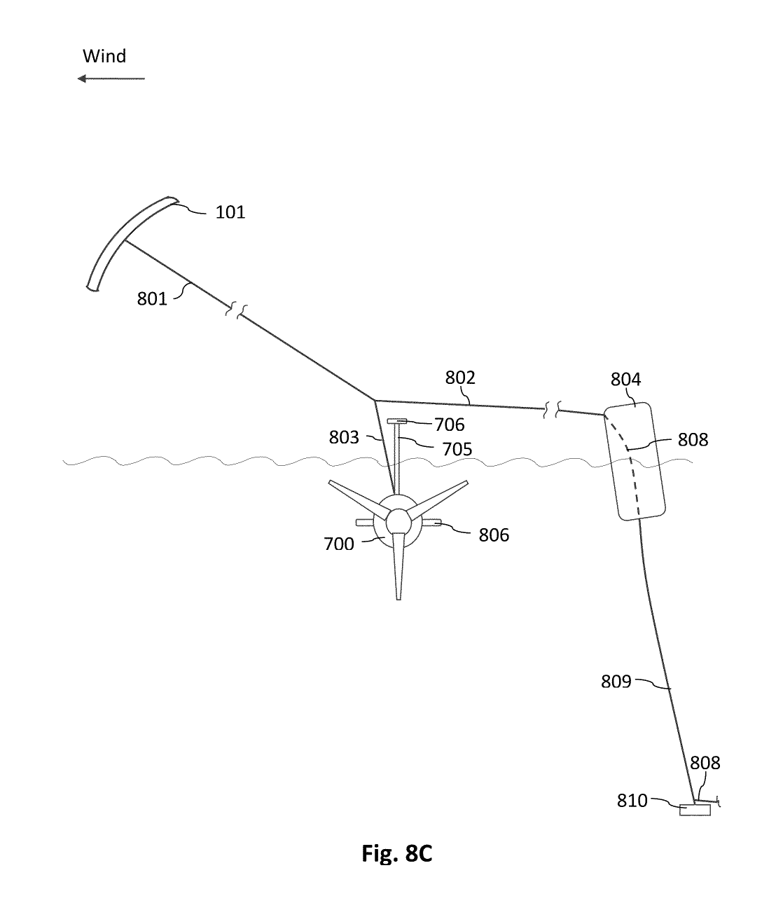

One more embodiment is shown in FIG. 8A, 8B, 8C. Referring to FIG. 8A, this embodiment comprises wing 101, a buoy 804, anchored to the bottom, and a vessel 805, travelling in an arc with a center at buoy 804. A tether 801 is attached to wing 101, a cable 802 is attached to buoy 804 by one end and to tether 801 by another end, a cable 803 is attached to vessel 805 by one end and to the attachment of cables 801 and 802 by its another end. Instead of buoy 804, there can be a pillar, driven into the bottom.

FIG. 8B shows more detail of vessel 805. Vessel 805 has a pair of underwater wings 806 and/or a ballast tank 807. Similarly to an embodiment shown in FIG. 7B and described above, vessel 805 comprises a mast 705 which is partially above water, an electronic subsystem 706 on top of mast 705 above the water and underwater control surfaces: yaw rudder 707 and a pitch rudder (diving plane) 708. On the pictures, yaw and pitch rudders are shown attached to a vertical and horizontal stabilizers, accordingly. A propeller 701 is installed on the forward part of vessel 805, and an electrical generator 702 is housed inside of vessel's watertight hull 700. An electrical cable 808 is connected to the armature of generator 702, eventually going through or along cable 803, then through or along cable 802, then connected to a converter, or a consumer or the grid.

FIG. 8C shows more details of this embodiment. Buoy 804 is anchored by a chain 809 to an anchor 810. Electrical cable 808 from generator 702 goes through buoy 804, then along chain 809, then on the bottom to a consumer, or to an intermediary concentrating/converting/transforming station of the wind farm. Vessel 805 moves along the arc back and forth, making U-turns in the ends of the arc. As vessel 805 is moving, relative water flow rotates propeller 701, which rotates rotor of generator 702 directly or through a simple gearbox. Generator 702 generates electrical energy. In operation, cable 803 pulls vessel 805 forward and up. Forward pull causes desirable forward movement. Upward pull is resisted by combination of vessel weight (including water in the ballast tank 807, if one is present), and downward hydrodynamic forces (hydrodynamic “lift”), acting on wings 806 (if present). Wings 806 have chamber (high pressure side) up. If ballast tank 807 is present, it is blown, when vessel is stopped. If no ballast tank is provided, vessel 805 should be buoyant. Multiple vessels 805 can be connected to a single buoy, and multiple wings can be connected to a single vessel 805. In many other aspects this embodiment is similar to the embodiments, described above. Certain enhancements and variations, described for the embodiments above, apply to this embodiment, too. This embodiment has an additional advantage that the electrical cable remains stretched and is not folded and unfolded frequently.

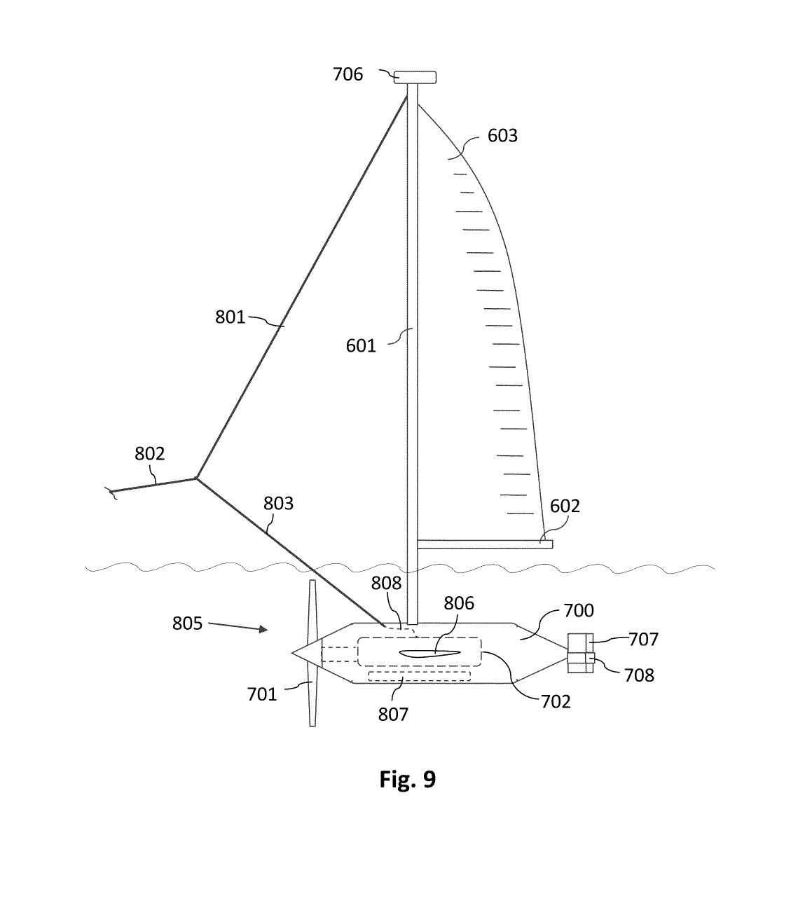

FIG. 9 shows another embodiment, having mast 601 and sail 603 instead of wing 101. Cable 803 is attached to the top of mast 601. In other aspects this embodiment is similar to the embodiments, in FIG. 7A-C and FIG. 8A-C.

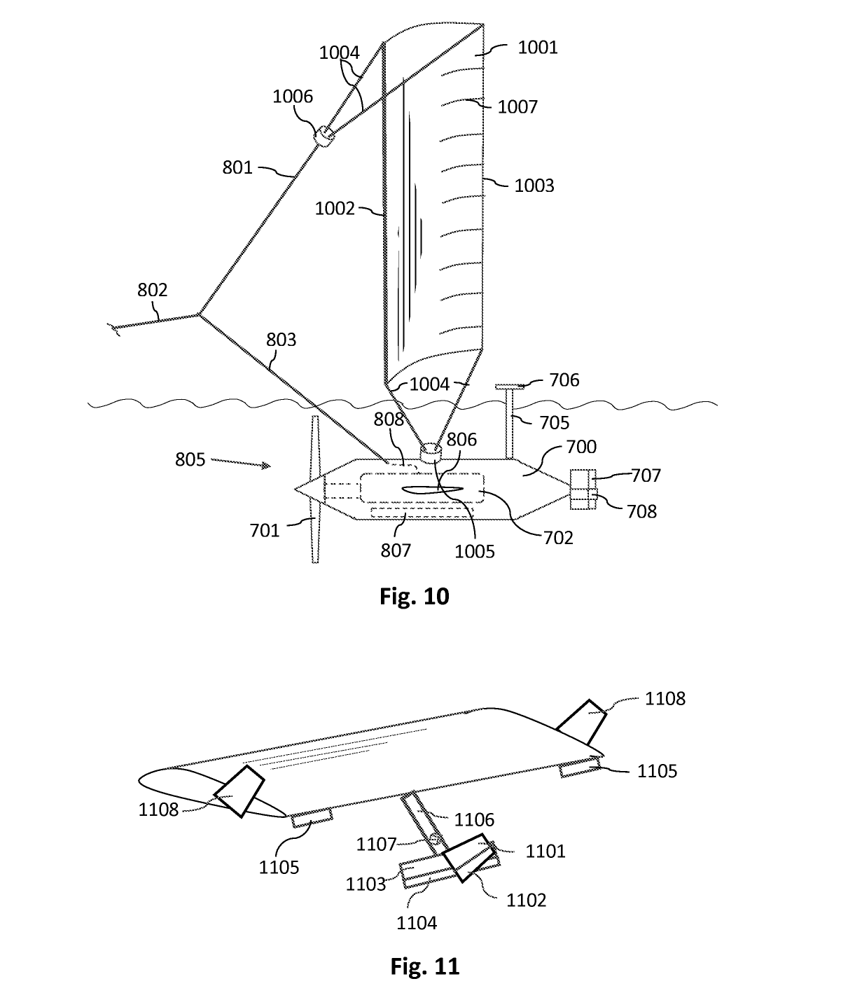

FIG. 10 shows one more embodiment, where vessel 805 is used with a mastless sail. It comprises a sail 1001 with a leading edge 1002 and a trailing edge 1003. Cables 1004 are connected in four corners of sail 1001. Bottom pair of cables 1004 is connected to a first actuating device 1005, attached to hull 700 of vessel 805. Top pair of cables 1004 is attached to a second actuating device 1006, which is held by the end of cable 801. Sail 1001 can be inflatable, like kite, or it can be made of soft fabric, including para-aramid, polyester or polyethylene. Battens 1007 can be utilized to help sail 1001 to keep its airfoil form, if single layer sail is used. Actuating devices 1005 and 1006 are managed by sail control subsystem of electronic block 706. Actuating devices 1005 and 1006 control position of sail 1001 by changing lengths of cables 1004. The position of sail 1001 is controlled in such a way, that the relative air flow keeps sail 1001 inflated and at the angle 45 to 75 degrees to true direction of the wind. In this embodiment, wind forces, acting on sail 1001 are propelling vessel 805 forward. In many other aspects this embodiment is similar to the embodiments, described above. Certain enhancements and variations, described for the embodiments above, apply to this embodiment, too.

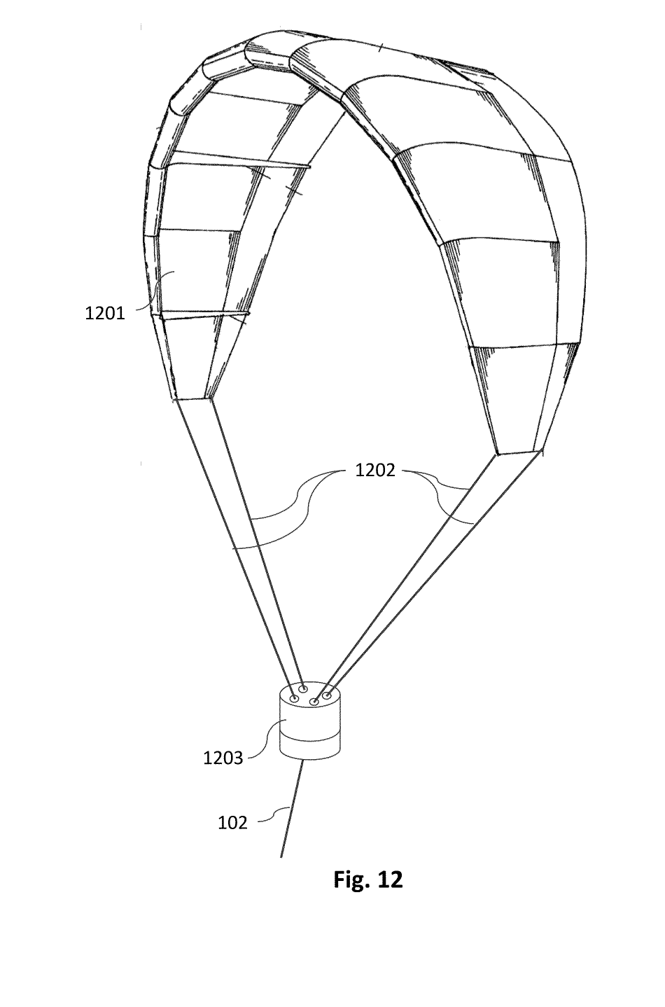

FIG. 11 shows possible form of the wing 101. It comprises a control sub-system 1107 and control surfaces. The control surfaces comprise a vertical stabilizer 1101, a rudder 1102, a horizontal stabilizer 1103, an elevator 1104, and ailerons 1105. The control surfaces 1101-1104 are installed on the end of a boom 1106 and can be combined between them in various combination (like in stabilators, V-tails etc.). Control sub-system 1107 executes commands of control system 112 or control system 706 or control system 106 and comprises a central processor or a microcontroller, sensors and actuators for the rudder, the elevator and the ailerons, communication means. An energy source is provided as well. The wing sensors may include speed meter, altimeter, accelerometer, gyroscopic sensor, GPS, stall warning device, attitude meter, bank meter, compass, cameras and other. The energy source can be a battery or a small turbine, working from the air flow. Additionally, spoilers or air brakes 1108 are attached near the tips of the wings. Spoiler 1108 helps the wing to perform sharp turns in the plane of the wing (yaws) without significant rolling. Such turns are useful at the extreme ends of the trajectory. For example, to perform left yaw turn, the left rudder-spoiler is rotated to become nearly perpendicular to the airflow direction (in addition to the action of the rudder 1102).

FIG. 12 shows another possible form of the wing 101. It comprises a flexible inflatable canopy 1201, at least four combined control and suspension cables 1202 and a control device 1203. In this form, position of the wing relative to the wind and to the horizon is controlled by dynamically changing the lengths of the cables 1202 by control device 1203. Control device 1203 also attaches wing 101 to tether 102 or 801.

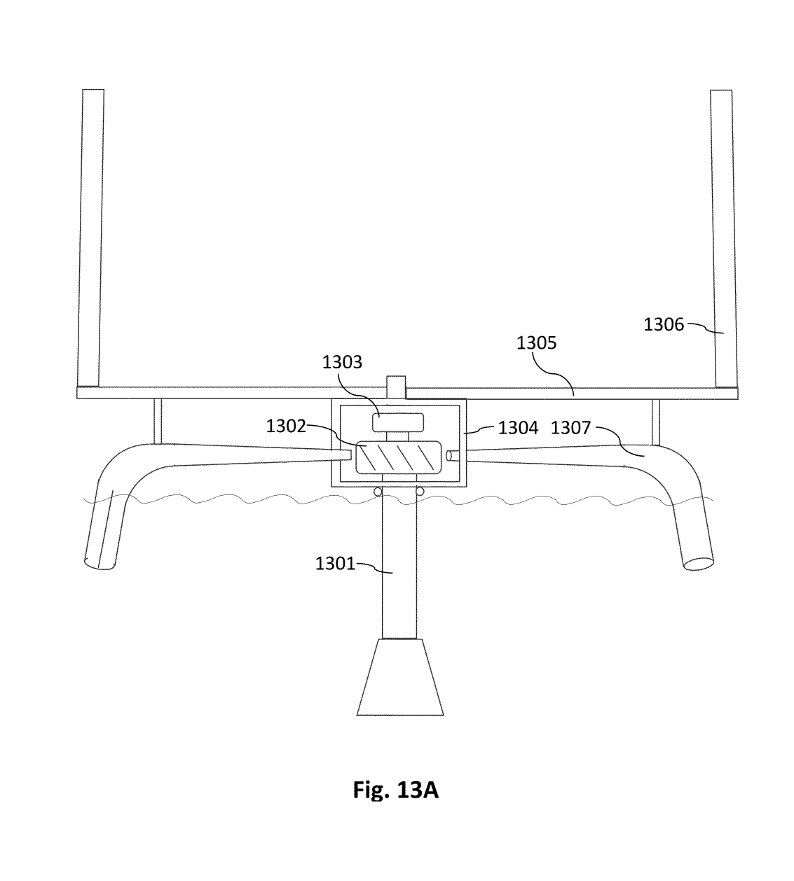

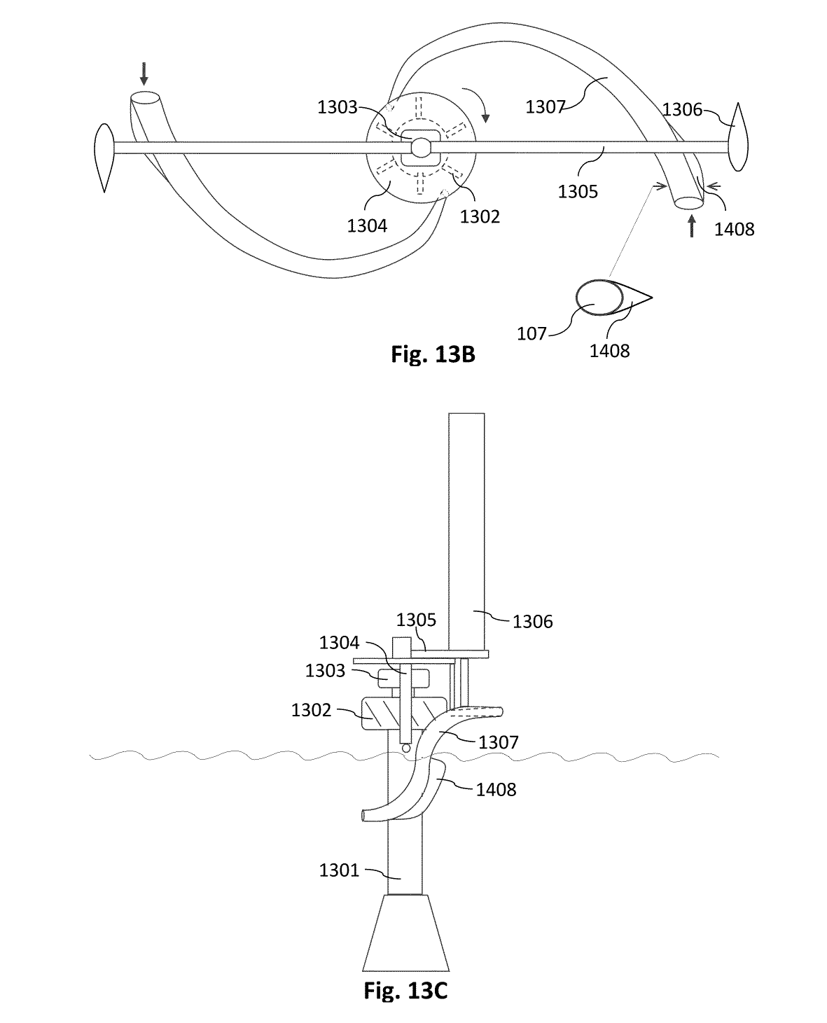

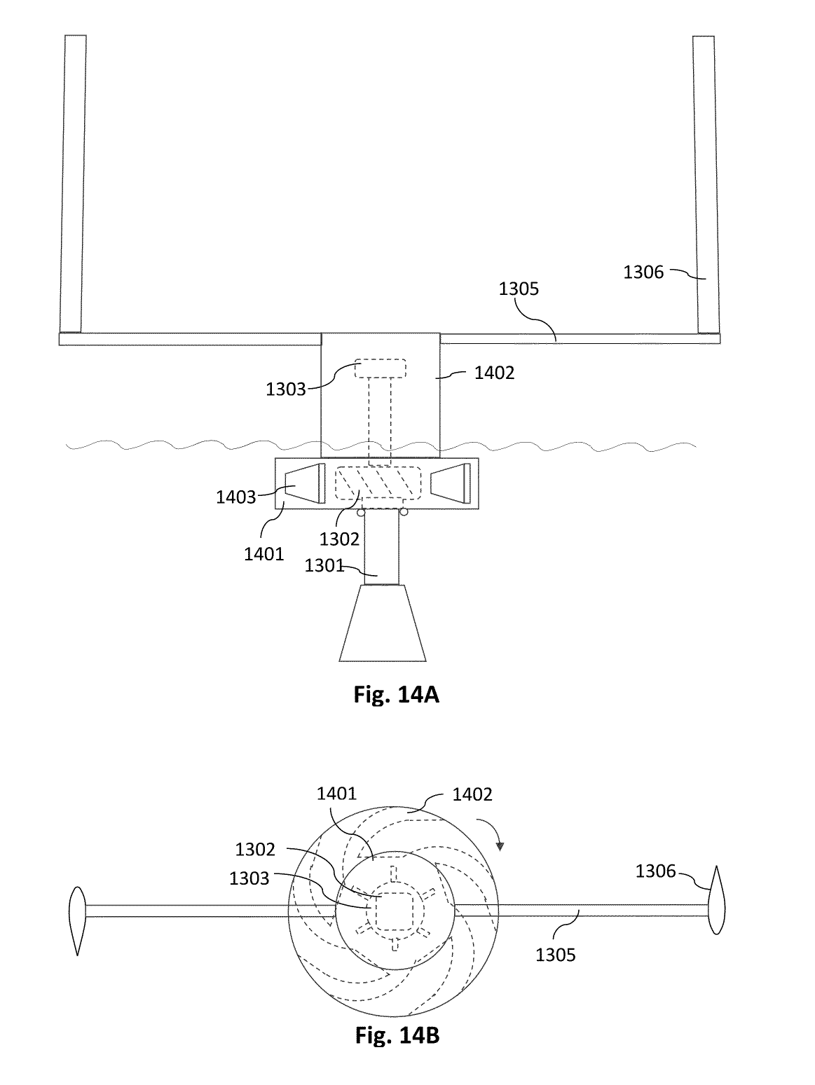

FIG. 13A-C show another embodiment of the invention. FIG. 13A is an isometric front view. FIG. 13B is an isometric top view. FIG. 13C is an isometric side view, perpendicular to the one on FIG. 13A, showing only one wing, cantilever and pipe. Waving line in FIG. 13A and FIG. 13C is the line of water. In this embodiment a vertical axis wind turbine has a base pole 1301, a water turbine 1302 installed on top of pole 1301, its axle rotating a rotor of an electrical generator 1303. A vertically oriented mount 1304 is installed on pole 1301 on bearings, letting it freely rotate in horizontal plane around pole 1301. Two or more cantilevers 1305 are attached to same mount 1304, each holding a turbine blade 1306. Further, each cantilever 1305 supports a curved pipe 1307, which rotates together with the cantilever and the blade. One end of pipe 1307 is submerged into water with its opening in the direction of its movement, so that the water enters it with the relative speed, equal to the linear speed of the end of the pipe. From that end, pipe 1307 is curving up and exits above the water. Above the water, pipe 1307 is curving into a substantially horizontal spiral, opening toward blades of turbine 1302. All transitions of the pipe are smooth in order to maintain laminar flow of the water in the pipe. Along above water spiral parts of pipe 1307, the sectional area of pipe 1307 decreases from periphery toward the center. Underwater section of pipe 1307 has a fairing 1408 attached, that helps to keep water flow behind the pipe laminar and decreases water resistance.

FIG. 13B shows direction of rotation, as visible from the top (clockwise). Thick arrows show how water enters pipe 1307. Also, FIG. 13B shows horizontal section of pipe 1307 with fairing 1408. The device also has foundation or anchoring, guy wires, additional stays for wings and other details, that are not shown.

As blades 1306 rotate around the center (axis of pole 1301) under impact of the wind, pipes 1307 rotate with them. Water enters pipe 1307 in its underwater opening and flows toward the center. It accelerates in the spiral part of the pipe and exits with high speed near the center, hitting blades of turbine 1302, and transferring to the turbine its impulse and energy. Turbine 1302 rotates the rotor of generator 1303, which produces electrical energy.

Impulse type turbines are preferred, such as Banki (cross flow) turbine, Tyson turbine, Turgo turbine or Pelton wheel. With small changes, other types of turbines can be used, such as Kaplan turbine or Francis turbine. Such turbines are well known in the art and are widely used in the conventional hydro power stations. Turbines can be installed horizontally or vertically. Electrical generator can be connected directly to the turbine or via a gearbox.

This embodiment can be practiced with blades of any configuration. This embodiment can be practiced also with airborne wings, such as kites or other flying airfoils instead of the blades. Use of kite wings instead of vertical turbine blades is known in the art, including from the European patent EP 1672214 by Ippolito and from U.S. patent application Ser. No. 12/593,804 by Ippolito et al. Pipes 1307 can have sections of various forms, and curves can be different, as long as the curvature accelerates flow of water from the periphery toward center. Pipe 1307 can be rigid or it can be a flexible hose. This embodiment can be used in oceans, seas, lakes, ponds and rivers. Also, it can be used on land, and the body of water can be created artificially for the turbine's use. This embodiment has excellent scalability, allowing to build VAWTs with diameter from few meters to kilometers. FIG. 14A-B show another embodiment of the invention. FIG. 14A is an isometric front view. FIG. 14B is an isometric top view. This embodiment is a vertical axis wind turbine, having a base pole 1301, a water turbine 1302 installed on top of pole 1301, its axle rotating a rotor of an electrical generator 1303. Also, a strong inlet barrel 1401 is installed on top of base pole 1301 and can rotate freely around it on bearings. Turbine 1302 is contained inside inlet barrel 1401 and both are submerged in the water, while generator 1303 is raised above the water. Inlet barrel 1401 has plurality of inlets 1403, preferably in the form of NACA ducts. On top of inlet barrel 1401 a generator housing 1402 is installed and attached. Two or more cantilevers 1305, each carrying a blades 1306, are attached to housing 1402.

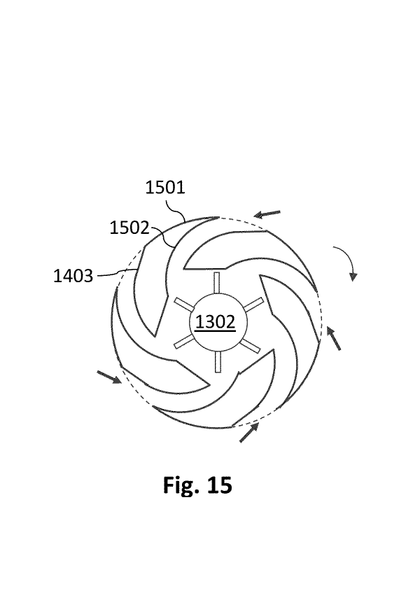

FIG. 15 shows horizontal section in the middle of inlet barrel 1401. Inlet barrel in the FIG. 3 has 5 inlets. FIG. 15 shows walls 1501 of the inlet barrel, walls of inlets 1403, internal walls 1502 and a schematic depiction of turbine 1302. Direction of water inflow is shown with thick arrows. In FIG. 2B, internal walls 1502 and inlet walls 1403 are shown in dashed lines. There are also holes in the bottom near center (not shown). Blades 1306 rotate around the center (axis of pole 1301), and inlet barrel 1307 rotates with them. Water enters through inlets 1403 and flows toward the center, accelerated and directed by inner walls 1502, hits blades of water turbine 1302, discharging its impulse and most of pressure, then exits through the holes in the bottom of inlet barrel 1307. This embodiment can utilize same types of the water turbine and wind blades, as the embodiment from FIG. 13A-C.

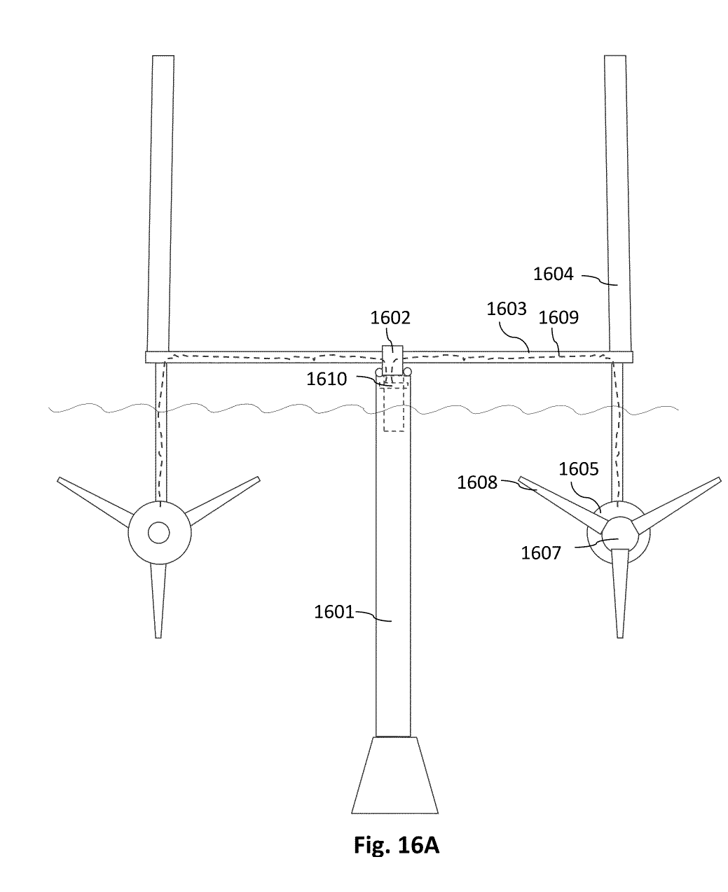

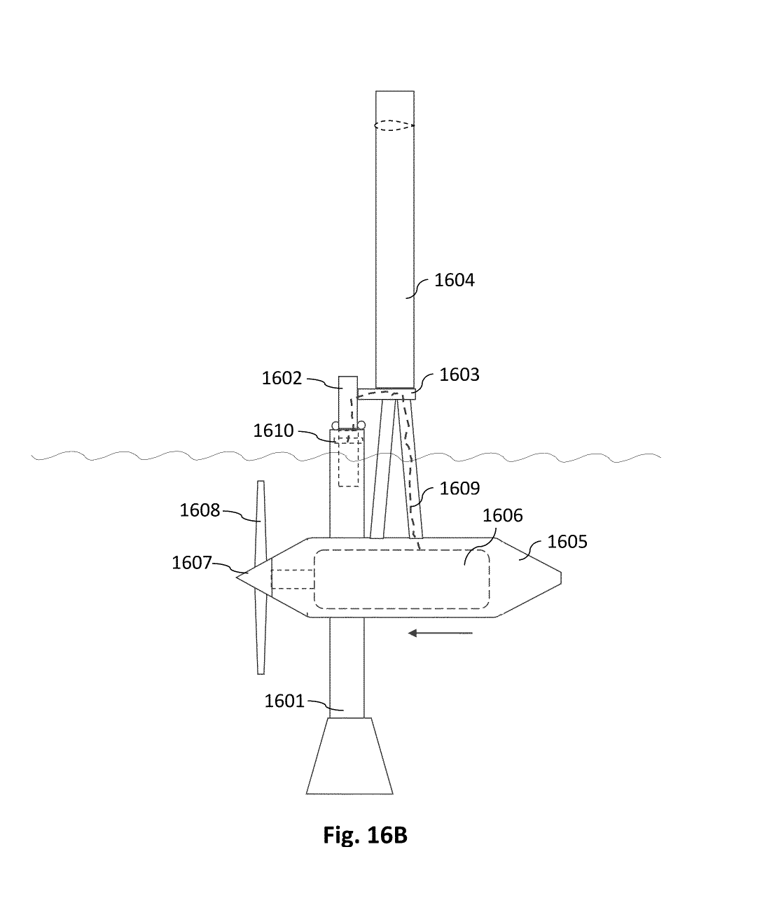

FIG. 16A-B show another embodiment of the invention. FIG. 16A is an isometric front view of variant of embodiment with two blade. The waving line in FIG. 16A is the line of water. FIG. 16B is an isometric side view showing only one blade. The arrow in FIG. 16B shows direction of the housing movement. This embodiment is a vertical axis wind turbine, having a base pole 1601, a shaft 1602, freely rotating on the pole, at least one cantilever 1603, attached to shaft 1602, and a wind turbine blade 1604, attached to the end of cantilever 1603. Cantilever 1603 supports a generator housing 1605 with an electrical generator 1606 inside. On the front side of housing 1605 there is a water propeller, comprising a hub 1607 and plurality of blades 1608. Hub 1607 of the water propeller is mechanically connected to the rotor of generator 1606. There is an electrical cable 1609 that goes from generator 1606. Electrical cable 1609 is connected to outgoing electrical cable inside of pole 1601 through a slip ring (or a brush) 1610. When the rotor of the wind turbine rotates under power of wind, housing 1605 with the underwater propeller moves in the water. The relative flow of the water rotates the underwater propeller, which transfers its rotation to the rotor of generator 1606. Generator 1606 produces electrical energy, which is transferred through cable 1609 and slip ring 1610 to the cable inside of pole 1601, that transfers it to the energy consumer.

This embodiment can be practiced with blades of any configuration. Two or more blades and two or more generators are preferable. Number of generators does not have to be the same, as the number of wings. As in the embodiments in FIG. 14-15, airborne wings or kites can be used instead of the wind turbine blades. The pictures show a generator inside of a streamlined housing underwater, but the generator can be held in its own housing above the water, and rotation of the propeller is transferred to it via a vertical shaft or a belt. Pole 1601 can incline from vertical, as long as both propellers stay under water. Variations of this embodiment can use a paddle wheel with axis above the water instead of the propeller. The VAWT diameter in this embodiment can be from 20 meters to 20 kilometers.

The embodiments in FIG. 14-15 solve two main problems of a vertical axis wind turbines, having blades on the periphery and the drivetrain in the center: difficulty in transfer of large forces over the large distance from the periphery to center over the radius of the turbine; and slow angular speed of the turbine, which necessitates a big and expensive gearbox between turbine and electrical generator (or an expensive direct drive generator). The embodiment in FIG. 16 solves the same problems by moving the drivetrain and the generator to the periphery. Thus, wind energy conversion system over water is described in conjunction with one or more specific embodiments. While above description contains many specificities, these should not be construed as limitations on the scope, but rather as exemplification of several embodiments thereof. More advantages, variations and modifications are apparent and/or possible and fall within the scope and the spirit of the invention.

What is claimed is:

1. A wind energy conversion system, comprising:
a wind attacked airfoil;
a moveable body submerged in water, coupled to the airfoil;
a motionless electrical generator, comprising a rotor and a stator;
a tether, coupling the wind attacked airfoil to the body, submerged in water;
a cable or belt, coupled to the body submerged in water and to the rotor in such way as to convert motion of the body submerged in water into rotation of the rotor.

2. The system of claim 1, wherein the airfoil is airborne and the body submerged in water is coupled to it by a flexible tether.

3. The system of claim 1, wherein a mast is installed on the body submerged in water, and the airfoil is formed by a sail, attached to the mast.

4. The system of claim 1, wherein the body submerged in water comprises a hydrofoil.

5. The system of claim 1, wherein the airfoil moves substantially cross wind.

6. The system of claim 1, wherein the body submerged in water moves substantially cross wind.

7. The system of claim 1, further comprising a drum, from which the cable or belt unreel.

8. A method for converting wind energy into electrical energy, comprising steps of:
providing a wind attacked airfoil;
providing an underwater foil surface;
providing a motionless electrical generator with a rotor and a stator;
using the airfoil to harvest wind energy and bring into motion the underwater foil surface;
converting the motion of the underwater foil surface into rotation of the rotor of the electrical generator by means of a cable or belt, unreeling from a drum;
transferring the generated electrical energy by an electrical cable to a destination on land.
